(19) United States
(12) Patent Application Publication
(10) Pub. No.: US 2026/0188957 A1
(43) Pub. Date: Jul. 2, 2026

(54) CHARGING DOCK and CHARGING DOCK ASSEMBLY

(71) Applicants: Tyco Electronics (Suzhou) Ltd., Suzhou City (CN); Tyco Electronics (Shanghai) Co., Ltd., Shanghai (CN); Tyco Electronics Technology (SIP) Co., Ltd., Suzhou (CN)

(72) Inventors: Fangyue (Jason) Zhu, Shanghai (CN); Tiancheng Cao, Suzhou (CN); Renyi (Ronny) Dou, Suzhou (CN); Jinshun (Jet) Wang, Suzhou (CN)

(73) Assignees: Tyco Electronics (Suzhou) Ltd., Suzhou City (CN); Tyco Electronics (Shanghai) Co., Ltd., Shanghai (CN); Tyco Electronics Technology (SIP) Co., Ltd., Suzhou (CN)

(21) Appl. No.: 19/435,962

(22) Filed: Dec. 30, 2025

(30) Foreign Application Priority Data
Dec. 31, 2024 (CN) 202411998257.0

(51) Int. Cl. H01R 13/66; B60L 53/16; G01K 1/14; G01K 1/16; H01R 13/642

(52) U.S. Cl. CPC H01R 13/6683; B60L 53/16; G01K 1/14; G01K 1/16; H01R 13/642; H01R 2201/26

(57) ABSTRACT

A charging dock includes a housing, a terminal assembly and a temperature detection module. The housing has a terminal socket and an insertion slot in communication therewith. The terminal assembly includes a power terminal inserted into the terminal socket. The temperature detection module is inserted into the insertion slot for detecting the temperature of the power terminal. The temperature detection module comprises a connector interface located outside the charging dock housing for mating with a connector. A limiting feature is formed on the charging dock housing. When the temperature detection module is inserted into a predetermined installation position, the limiting feature does not interfere with a connector housing to allow the connector to mate with the connector interface. When the temperature detection module is not inserted into the predetermined installation position, the limiting feature interferes with the connector housing, preventing the connector from being mated with the connector interface.

### CROSS-REFERENCE TO RELATED APPLICATION

This application claims the benefit of Chinese Patent Application No. CN202411998257.0 filed on Dec. 31, 2024 in the State Intellectual Property Office of China, the whole disclosure of which is incorporated herein by reference.

### FIELD OF THE INVENTION

The disclosure relates to a charging dock and a charging dock assembly comprising the charging dock.

### BACKGROUND OF THE INVENTION

In the prior art, in order to charge a battery pack of electric vehicles, it is necessary to install a charging dock suitable for mating with a charging gun on vehicle. In order to improve charging speed, it is necessary to increase the charging current. Currently, the charging current is as high as 600A, and it may even increase to 1000A in the future. When a large current flows through the power terminal inside the charging dock, a large amount of heat is generated, which can cause the temperature of the power terminal inside the charging dock to rise sharply. If the temperature rise cannot be controlled in time, it can lead to safety accidents, such as burning the charging dock or other electrical equipment.

In the prior art, in order to control the temperature rise of power terminals, a lead frame is usually installed in the charging dock and a temperature detection module is integrated on the lead frame. The temperature detection module includes a temperature sensor and a thermal pad wrapped around the outside of the temperature sensor. The thermal pad is in thermal contact with the power terminal, and the temperature sensor is electrically connected to the lead frame. However, in the prior art, the lead frame has a large volume and needs to be pre-installed in the charging dock housing, which is very inconvenient to use. In addition, in the prior art, in order to facilitate the installation of lead frame, the charging dock housing needs to adopt a split design, which leads to a complex structure of the charging dock housing. In addition, the existing lead frame needs to be able to rotate between a locking position of locking the power terminal and an unlocking position of unlocking the power terminal, which will make the lead frame and charging dock housing more complex, assembly more difficult, and cost higher.

### SUMMARY OF THE INVENTION

According to an embodiment of the present disclosure, a charging dock includes a housing, a terminal assembly and a temperature detection module. The housing is formed with a terminal socket and an insertion slot communicated with the terminal socket. The terminal assembly includes a power terminal and inserted into the terminal socket. The temperature detection module is inserted into the insertion slot from the outside of the charging dock housing for detecting the temperature of the power terminal. The temperature detection module comprises a connector interface located outside the charging dock housing for mating with a connector. A limiting feature is formed on the charging dock housing. When the temperature detection module is inserted into a predetermined installation position, the limiting feature is in a position that does not interfere with a connector housing to allow the connector to mate with the connector interface. When the temperature detection module is not inserted into the predetermined installation position, the limiting feature is in a position that interferes with the connector housing, preventing the connector from being mated with the connector interface.

### BRIEF DESCRIPTION OF DRAWINGS

The above and other features of the present invention will become more apparent by describing in detail exemplary embodiments thereof with reference to the accompanying drawings, in which:

FIG. 1 shows an illustrative perspective view of a temperature detection module according to an exemplary embodiment of the present invention when viewed from one side;

FIG. 2 shows an illustrative exploded view of a temperature detection module according to an exemplary embodiment of the present invention when viewed from one side;

FIG. 3 shows an illustrative exploded view of a temperature detection module according to an exemplary embodiment of the present invention when viewed from the other side;

FIG. 4 shows an illustrative perspective view of a temperature detection module according to an exemplary embodiment of the present invention when viewed from the other side;

FIG. 5 shows an illustrative assembly view of a thermal pad and a temperature sensor of a temperature detection module according to an exemplary embodiment of the present invention;

FIG. 6 shows an illustrative exploded view of the thermal pad and temperature sensor of the temperature detection module according to an exemplary embodiment of the present invention;

FIG. 7 shows an illustrative exploded view of the insulator and conductive leads of a temperature detection module according to an exemplary embodiment of the present invention;

FIG. 8 shows an illustrative view of the electrical connection between the conductive leads of the temperature detection module and the temperature sensor according to an exemplary embodiment of the present invention;

FIG. 9 shows an illustrative perspective view of a temperature detection module according to an exemplary embodiment of the present invention;

FIG. 10 shows an illustrative perspective view of a charging dock according to an exemplary embodiment of the present invention;

FIG. 11 shows an illustrative exploded view of a charging dock according to an exemplary embodiment of the present invention;

FIG. 12 shows an exploded sectional view of a charging dock according to an exemplary embodiment of the present invention;

FIG. 13 shows an axial sectional view of a charging dock according to an exemplary embodiment of the present invention;

FIG. 14 shows an illustrative perspective view of a charging dock assembly according to an exemplary embodiment of the present invention;

FIG. 15 shows an illustrative exploded view of a charging dock assembly according to an exemplary embodiment of the present invention;

FIG. 16 shows a cross-sectional view of a charging dock assembly according to an exemplary embodiment of the present invention, where the connector has not yet been mated with the connector interface;

FIG. 17 shows a cross-sectional view of a charging dock assembly according to an exemplary embodiment of the present invention, wherein the connector has been mated with the connector interface;

FIG. 18 shows a cross-sectional view of a charging dock assembly according to an exemplary embodiment of the present invention, in which the temperature detection module is not inserted into the predetermined installation position, and the limiting feature hinders the connector from being mated with the connector interface;

FIG. 19 shows an illustrative perspective view of a charging dock assembly according to another exemplary embodiment of the present invention; and

FIG. 20 shows an illustrative exploded view of a charging dock assembly according to another exemplary embodiment of the present invention.

The features disclosed in this disclosure will become more apparent in the following detailed description in conjunction with the accompanying drawings, where similar reference numerals always identify the corresponding components. In the accompanying drawings, similar reference numerals typically represent identical, functionally similar, and/or structurally similar components. Unless otherwise stated, the drawings provided throughout the entire disclosure should not be construed as drawings drawn to scale.

### DETAILED DESCRIPTION

Exemplary embodiments of the present disclosure will be described hereinafter in detail with reference to the attached drawings, wherein like reference numerals refer to like elements. The present disclosure may, however, be embodied in many different forms and should not be construed as being limited to the embodiments set forth herein; rather, these embodiments are provided so that the present disclosure will convey the concept of the disclosure to those skilled in the art. Exemplary embodiments of the present disclosure will be described hereinafter in detail with reference to the attached drawings, wherein the like reference numerals refer to the like elements. The present disclosure may, however, be embodied in many different forms and should not be construed as being limited to the embodiment set forth herein; rather, these embodiments are provided so that the present disclosure will be thorough and complete, and will fully convey the concept of the disclosure to those skilled in the art.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

According to a general concept of the present invention, there is provided a charging dock. The charging dock comprises: a charging dock housing which is formed with a terminal socket and an insertion slot communicated with the terminal socket; a terminal assembly comprising a power terminal and inserted into the terminal socket; and a temperature detection module which is inserted into the insertion slot from the outside of the charging dock housing for detecting the temperature of the power terminal. The temperature detection module comprises a connector interface located outside the charging dock housing for mating with a connector, a limiting feature is formed on the charging dock housing. When the temperature detection module is inserted into a predetermined installation position, the limiting feature is in a position that does not interfere with a connector housing to allow the connector to mate with the connector interface; when the temperature detection module is not inserted into the predetermined installation position, the limiting feature is in a position that interferes with the connector housing, preventing the connector from being mated with the connector interface.

According to another general concept of the present invention, there is provided a charging dock assembly. The charging dock assembly comprises: the above charging dock; and a connector which is mated with the connector interface of the temperature detection module of the charging dock.

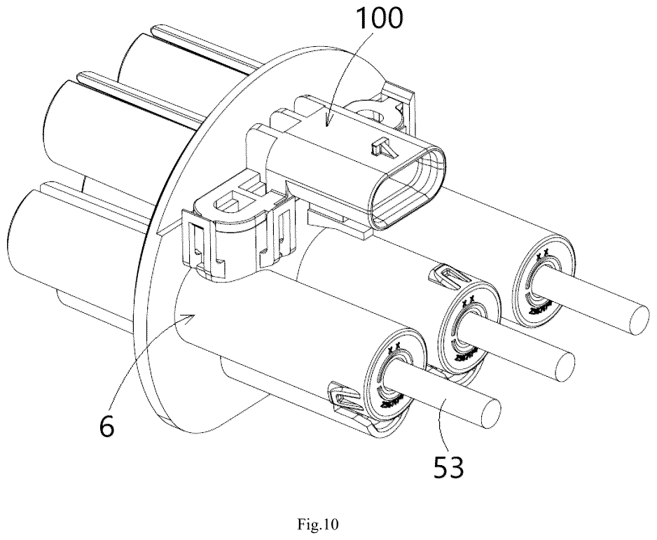

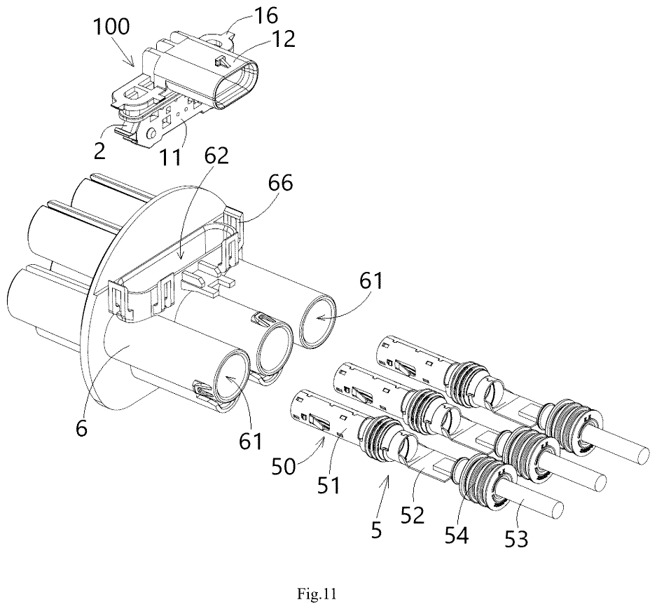

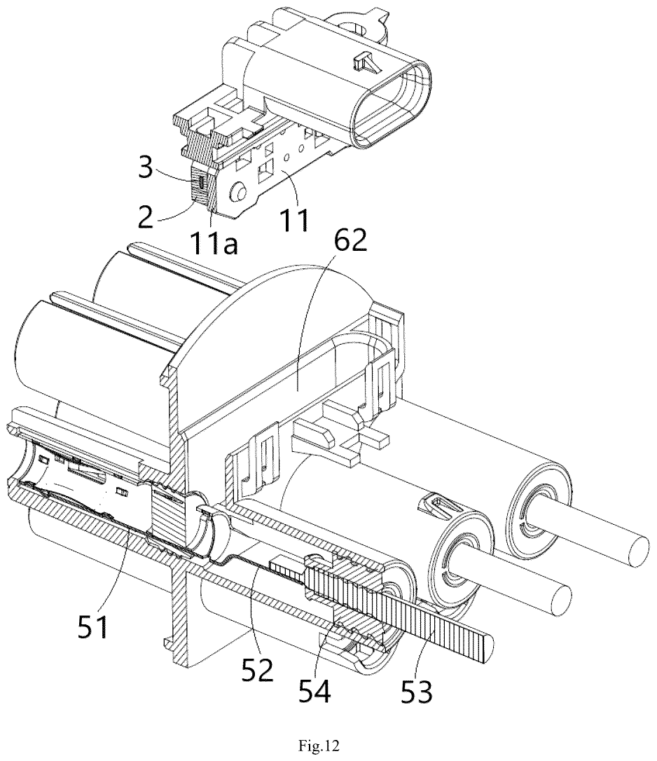

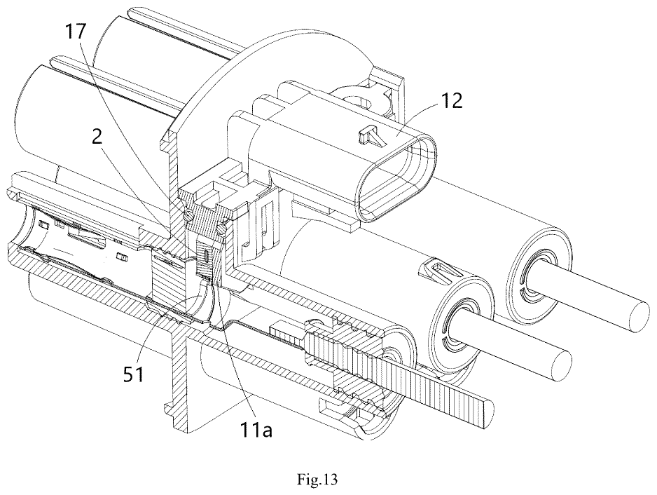

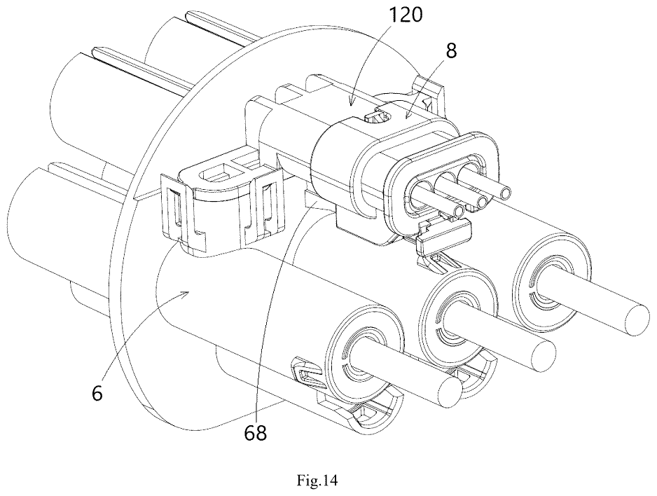

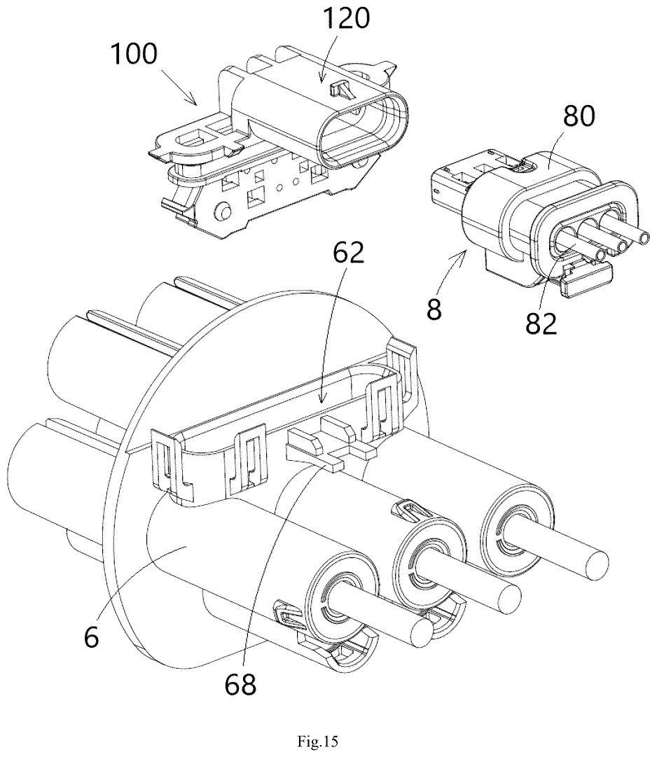

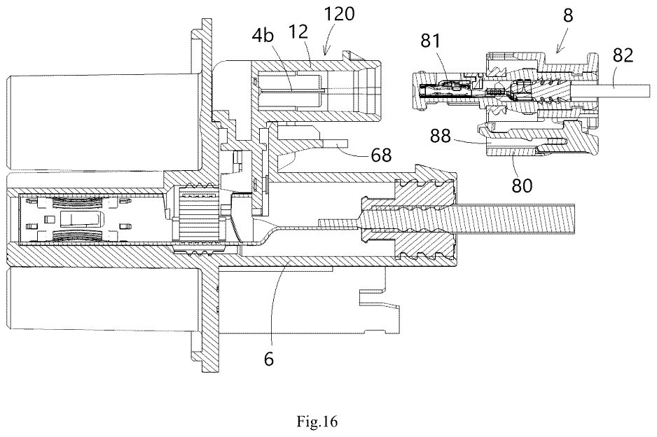

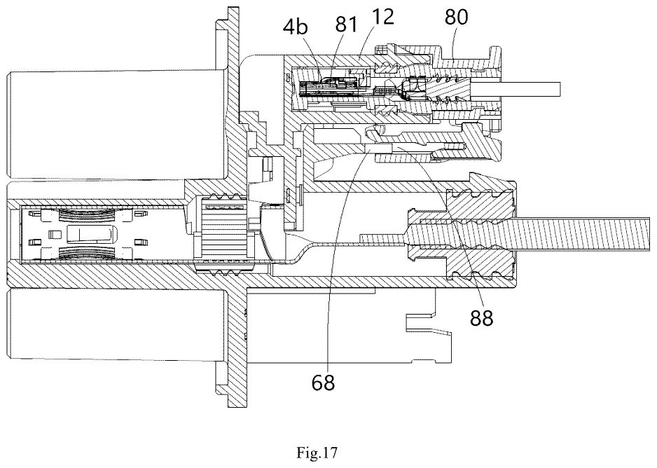

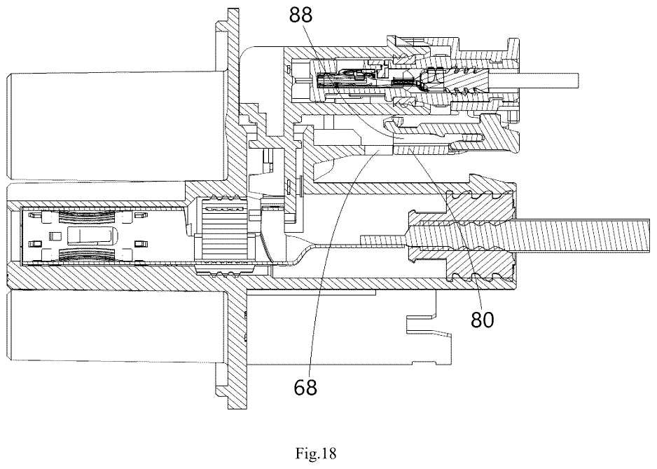

FIG. 10 shows an illustrative perspective view of a charging dock according to an exemplary embodiment of the present invention. FIG. 11 shows an illustrative exploded view of a charging dock according to an exemplary embodiment of the present invention. FIG. 12 shows an exploded sectional view of a charging dock according to an exemplary embodiment of the present invention. FIG. 13 shows an axial sectional view of a charging dock according to an exemplary embodiment of the present invention. FIG. 14 shows an illustrative perspective view of a charging dock assembly according to an exemplary embodiment of the present invention. FIG. 15 shows an illustrative exploded view of a charging dock assembly according to an exemplary embodiment of the present invention. FIG. 16 shows a cross-sectional view of a charging dock assembly according to an exemplary embodiment of the present invention, where connector 8 has not yet been mated with connector interface 120. FIG. 17 shows a cross-sectional view of a charging dock assembly according to an exemplary embodiment of the present invention, wherein connector 8 has been mated with connector interface 120. FIG. 18 shows a cross-sectional view of a charging dock assembly according to an exemplary embodiment of the present invention, in which the temperature detection module 100 is not inserted into the predetermined installation position, and the limiting feature 68 hinders the mating of the connector 8 with the connector interface 120.

As shown in FIGS. 10-18, in an exemplary embodiment of the present invention, a charging dock is disclosed. The charging dock includes: a charging dock housing 6, a terminal assembly 5, and a temperature detection module 100. The charging dock housing 6 is formed with a terminal socket 61 and an insertion slot 62 communicated with the terminal socket 61. The terminal assembly 5 includes a power terminal 50 and is inserted into terminal socket 61. The temperature detection module 100 is inserted from the outside of the charging dock housing 6 into the insertion slot 62 to detect the temperature of the power terminal 50. The temperature detection module 100 includes a connector interface 120 located outside the charging dock housing 6 for mating with a connector 8.

A limiting feature 68 is formed on the exterior of the charging dock housing 6. When the temperature detection module 100 is inserted into a predetermined installation position, the limiting feature 68 is in a position that does not interfere with the connector housing 80, allowing the connector 8 to mate with the connector interface 120. When the temperature detection module 100 is not inserted into the predetermined installation position, the limiting feature 68 is in a position that interferes with the connector housing 80 (as shown in FIG. 18), preventing the connector 8 from being mated with the connector interface 120. Therefore, in the illustrated embodiment, only when the temperature detection module 100 is inserted into the predetermined installation position, the limiting feature 68 on the charging dock housing 6 will not hinder the mating of the connector 8 with the connector interface 120 of the temperature detection module 100. Therefore, the present invention can ensure that the temperature detection module 100 is inserted into the predetermined installation position.

The limiting feature 68 is adapted to engage with a mating feature 88 on the connector housing 80. When the temperature detection module 100 is inserted into the predetermined installation position and the connector 8 is mated with the connector interface 120, the limiting feature 68 on the charging dock housing 6 engages with the mating feature 88 on the connector housing 80, so that the connector housing 80 is engaged to the charging dock housing 6, enabling the connector 8 and the connector interface 120 to withstand large external forces and not be damaged by external forces.

The limiting feature 68 on the charging dock housing 6 is a protruding tongue shaped and suitable for engagement with the slot (i.e., the aforementioned mating feature 88) on the connector housing 80. However, the present invention is not limited to the illustrated embodiments. For example, the limiting feature 68 on the charging dock housing 6 may have a protruding cylindrical shape and be adapted to engage with the slot on the connector housing 80.

When the temperature detection module 100 is inserted into the predetermined installation position, the limiting feature 68 is aligned with the mating feature 88 on the connector housing 80 to allow the connector 8 to mate with the connector interface 120. When the temperature detection module 100 is not inserted into the predetermined installation position, the limiting feature 68 is not aligned with the mating feature 88 on the connector housing 80, preventing the connector 8 from being mated with the connector interface 120. As shown in FIG. 18, when the temperature detection module 100 is not inserted into the predetermined installation position, the limiting feature 68 will press against the front-end face of the connector housing 80, hindering the mating between the connector 8 and the connector interface 120.

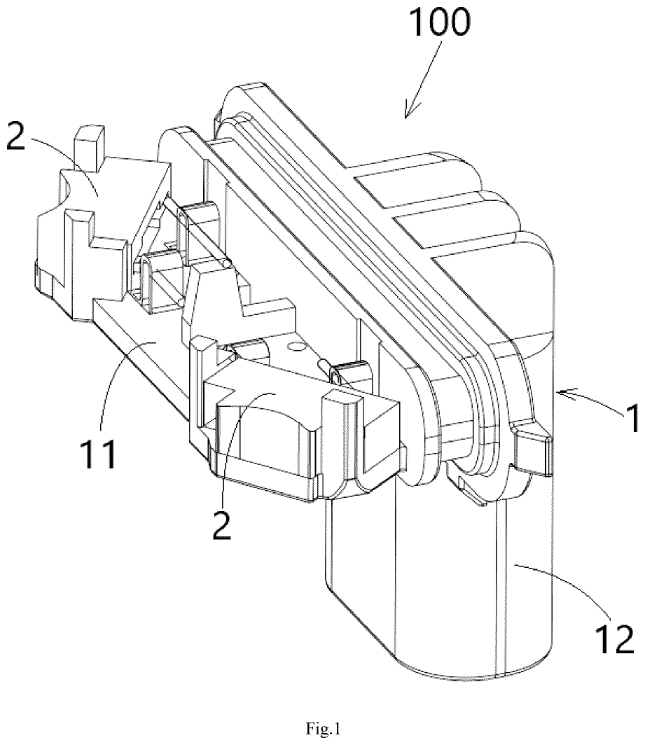

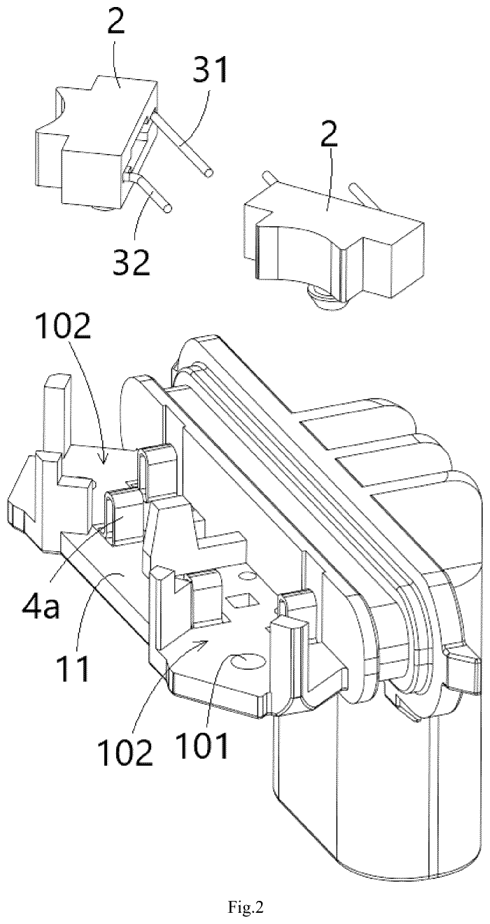

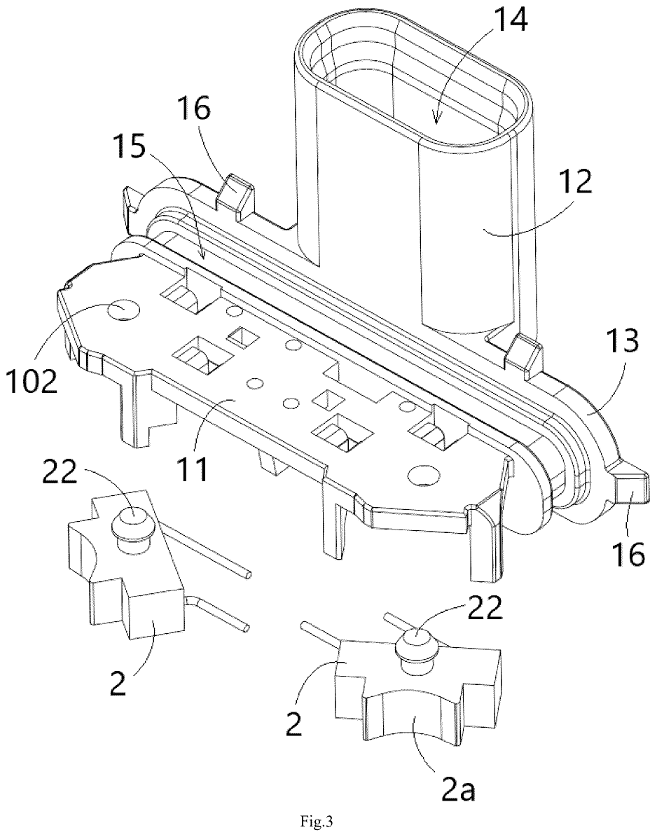

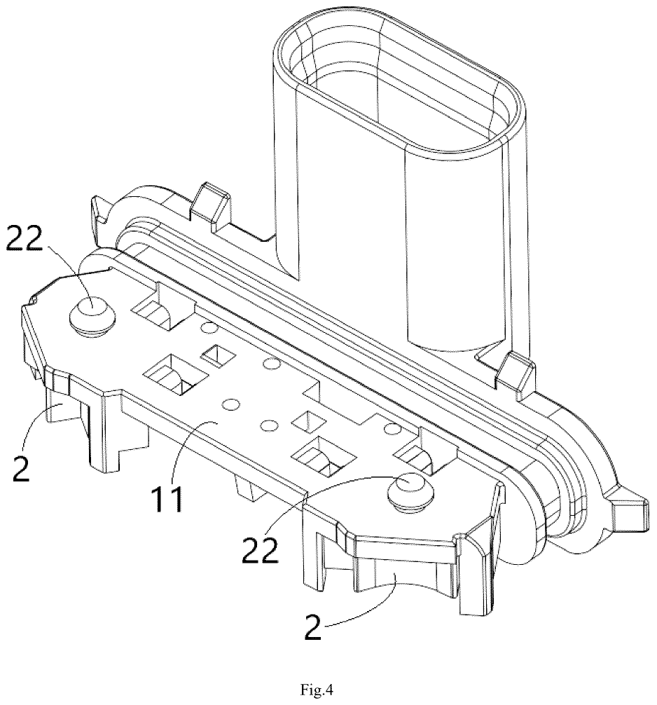

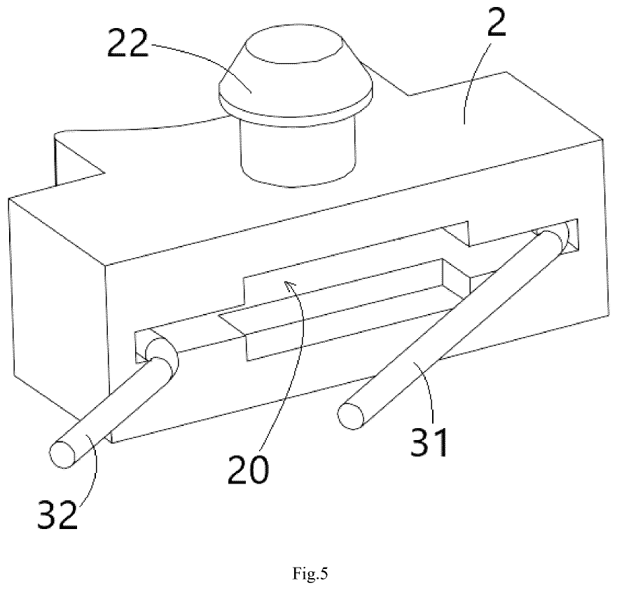

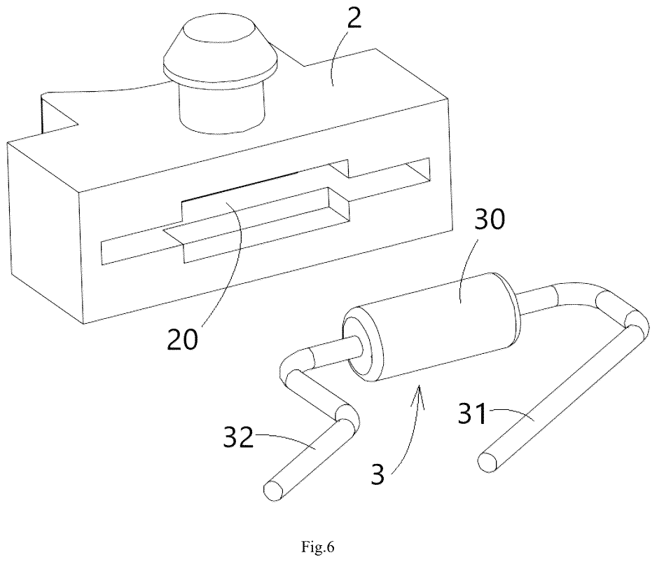

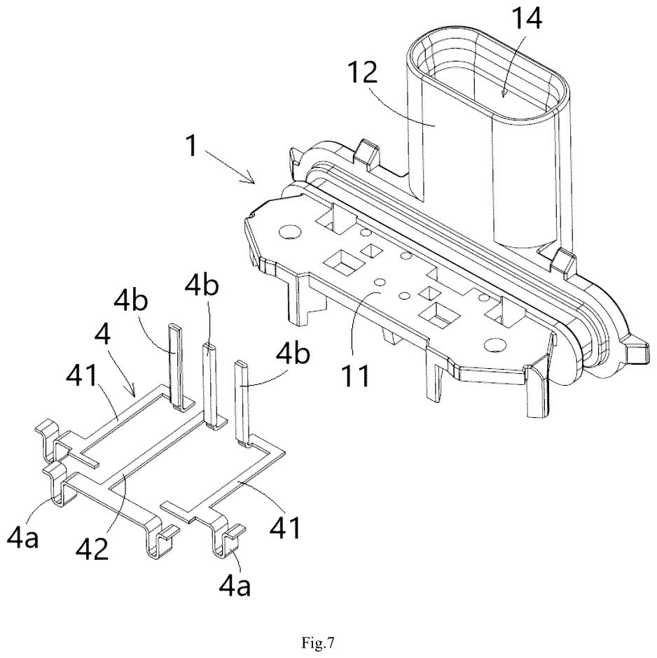

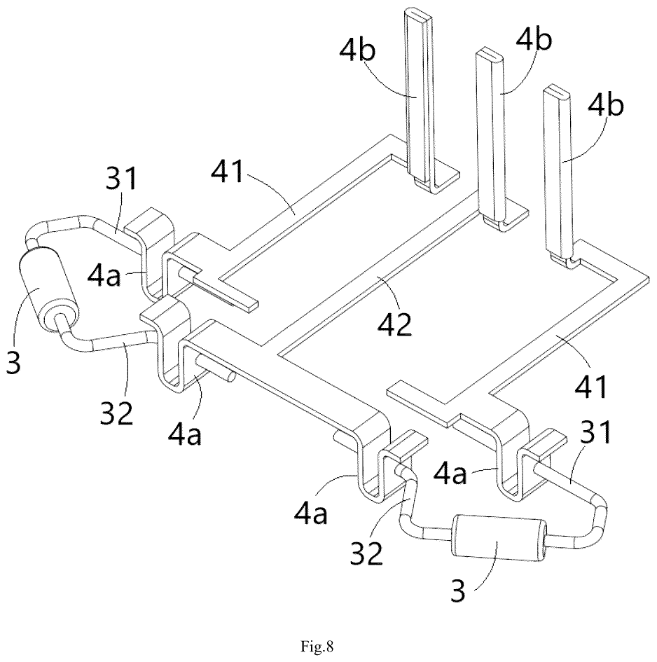

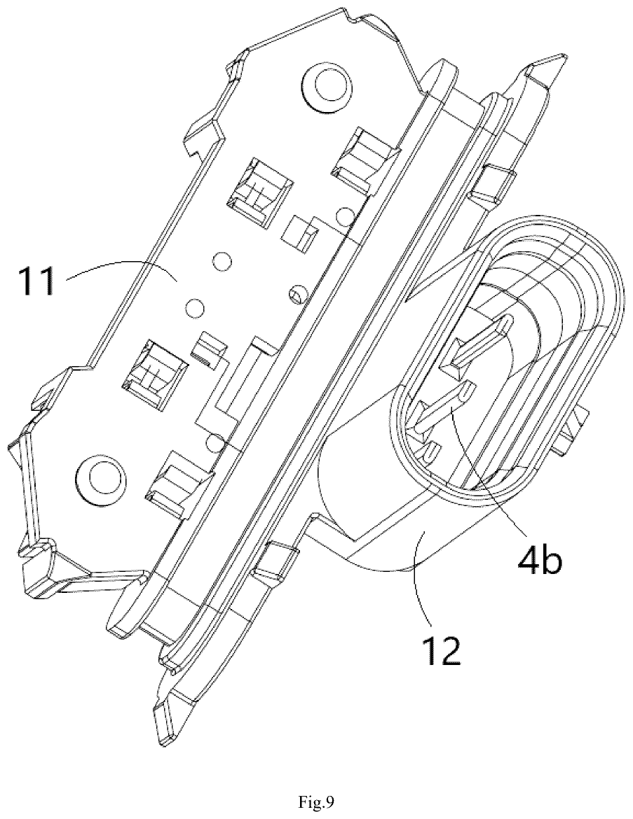

FIG. 1 shows an illustrative perspective view of a temperature detection module 100 according to an exemplary embodiment of the present invention when viewed from one side. FIG. 2 shows an illustrative exploded view of a temperature detection module 100 according to an exemplary embodiment of the present invention when viewed from one side. FIG. 3 shows an illustrative exploded view of the temperature detection module 100 according to an exemplary embodiment of the present invention when viewed from the other side. FIG. 4 shows an illustrative perspective view of the temperature detection module 100 according to an exemplary embodiment of the present invention when viewed from the other side. FIG. 5 shows an illustrative assembly view of the thermal pad 2 and temperature sensor 3 of the temperature detection module 100 according to an exemplary embodiment of the present invention. FIG. 6 shows an illustrative exploded view of the thermal pad 2 and temperature sensor 3 of the temperature detection module 100 according to an exemplary embodiment of the present invention. FIG. 7 shows an illustrative exploded view of the insulator 1 and conductive lead 4 of the temperature detection module 100 according to an exemplary embodiment of the present invention. FIG. 8 shows an illustrative view of the electrical connection between the conductive lead 4 and the temperature sensor 3 of the temperature detection module 100 according to an exemplary embodiment of the present invention. FIG. 9 shows an illustrative perspective view of a temperature detection module 100 according to an exemplary embodiment of the present invention.

As shown in FIGS. 1-18, in the illustrated embodiment, the temperature detection module 100 includes an insulator 1, a thermal pad 2, a temperature sensor 3, and a conductive lead 4. The thermal pad 2 is assembled onto the insulator 1 for thermal contact with the power terminal 50 (see FIG. 13) of the charging dock. The temperature sensor 3 is provided in thermal pad 2 to detect the temperature of power terminal 50. The conductive lead 4 is set in the insulator 1 and electrically connected to the temperature sensor 3.

In the illustrated embodiment, the temperature detection module 100 is adapted to be installed in a pluggable manner from the outside of the charging dock housing 6 into the insertion slot 62 in the charging dock housing 6. The thermal pad 2 is in thermal contact with the power terminal 50 when the temperature detection module 100 is installed in the insertion slot 62 to transfer the heat of the power terminal 50 to the temperature sensor 3.

When the temperature detection module 100 is not inserted into the predetermined installation position, it may cause the thermal pad 2 to not be in reliable thermal contact with the power terminal 50. In order to ensure reliable thermal contact between the thermal pad 2 and the power terminal 50, the temperature detection module 100 must be plugged into the predetermined installation position mentioned above.

As shown in FIGS. 1-13, in the illustrated embodiment, the insulator 1 is an injection molded part directly injected onto the conductive lead 4, so that the conductive lead 4 and the insulator 1 become an integrated piece. However, the present invention is not limited to the illustrated embodiment. For example, in another exemplary embodiment of the present invention, a slot is formed on the insulator 1, and the conductive lead 4 is held and fixed in the slot on the insulator 1. The conductive lead 4 has a connection end 4a for electrical connection with the temperature sensor 3 and an external pin 4b for electrical connection with the connector 8 located outside the charging dock housing 6.

The insulator 1 includes a bracket part 11 and a mating part 12. The bracket part 11 is suitable for inserting into the insertion slot 62 of the charging dock housing 6. The mating part 12 is adapted to be positioned on the outside of the charging dock housing 6, for mating with the connector 8 located on the outside of the charging dock housing 6. The thermal pad 2 and temperature sensor 3 are installed on the bracket part 11, and the mating part 12 has an insertion cavity 14 that allows the connector 8 to be inserted. The external pin 4b of the conductive lead 4 extends into the insertion cavity 14 to electrically connect with the inserted connector 8. In the illustrated embodiment, the mating part 12 of the insulator 1 and the external pin 4b of the conductive lead 4 together form the connector interface 120 for mating with the connector 8.

A sealing ring installation groove 15 is formed on the outer peripheral surface of the bracket part 11. The temperature detection module 100 also includes a sealing ring 17 installed in the sealing ring installation groove 15, which is suitable for being compressed between the bracket part 11 and the inner wall surface of the insertion slot 62 of the charging dock housing 6 to achieve sealing between the two.

The bracket part 11 has a cover plate part 13 for covering the entrance of the insertion slot 62 of the charging dock housing 6. Multiple protrusions 16 are formed on the outer peripheral surface of the cover plate part 13, which are distributed around the outer periphery of the cover plate part 13 and are used to engage with multiple buckles 66 on the charging dock housing 6, respectively, to lock the temperature detection module 100 into the insertion slot 62 of the charging dock housing 6.

The conductive lead 4 includes a positive lead 41 and a negative lead 42 electrically connected to the positive pin 31 and the negative pin 32 of the temperature sensor 3, respectively. The external pins 4b of the positive lead 41 and the negative lead 42 extend into the insertion cavity 14 of the mating part 12 for electrical connection with the inserted connector 8.

The connection end 4a of the positive lead 41 is suitable for plug-in electrical connection with the positive pin 31 of the temperature sensor 3. The connection end 4a of the negative lead 42 is suitable for plug-in electrical connection with the negative pin 32 of the temperature sensor 3. However, the present invention is not limited to the illustrated embodiment. For example, the connection end 4a of the positive lead 41 may be welded, crimped, or riveted to the positive pin 31 of the temperature sensor 3. The connection end 4a of the negative lead 42 may be welded, crimped, or riveted to the negative pin 32 of the temperature sensor 3.

The connection end 4a of the positive lead 41 is in an elastic clip shape, suitable for clamping the positive pin 31 of the temperature sensor 3. The connection end 4a of the negative lead 42 is in an elastic clip shape, suitable for clamping the negative pin 32 of the temperature sensor 3.

The temperature detection module 100 includes multiple thermal pads 2 and multiple temperature sensors 3 respectively arranged in the multiple thermal pads 2. The multiple thermal pads 2 are used to make thermal contact with multiple power terminals 50, and the multiple temperature sensors 3 are used to detect the temperature of the multiple power terminals 50, respectively.

The conductive lead 4 includes multiple positive leads 41 and a single negative lead 42. The connection ends 4a of multiple positive leads 41 are respectively electrically connected to the positive pins 31 of multiple temperature sensors 3, and the single negative lead 42 has multiple connection ends 4a that are respectively electrically connected to the negative pins 32 of multiple temperature sensors 3. The external pins 4b of multiple positive leads 41 and the external pins 4b of the single negative lead 42 extend into the insertion cavity 14 of the mating part 12 for electrical connection with the inserted connector 8.

However, the present invention is not limited to the illustrated embodiment. For example, in another exemplary embodiment of the present invention, the conductive lead 4 includes multiple positive leads 41 and multiple negative leads 42. The connection ends 4a of multiple positive leads 41 are respectively electrically connected to the positive pins 31 of multiple temperature sensors 3, and the connection ends 4a of multiple negative leads 42 are respectively electrically connected to the negative pins 32 of multiple temperature sensors 3. The external pins 4b of multiple positive leads 41 and multiple negative leads 42 extend into the insertion cavity 14 of the mating part 12 for electrical connection with the inserted connector 8.

Still referring to FIGS. 1-13, in the illustrated embodiment, the thermal pad 2 is in the form of a block, and a recessed receiving part 101 is formed on the insulator 1. The thermal pad 2 is positioned and installed in the receiving part 101. A socket 102 is formed in the insulator 1, and an elastic buckle 22 is formed on the thermal pad 2 to engage with the socket 102, in order to lock the thermal pad 2 onto the insulator 1.

A mounting slot 20 is formed in the thermal pad 2, and the main body 30 of the temperature sensor 3 is inserted into the mounting slot 20 of the thermal pad 2. The positive pin 31 and negative pin 32 of the temperature sensor 3 extend from the thermal pad 2. However, the present invention is not limited to the illustrated embodiment. For example, in another exemplary embodiment of the present invention, the thermal pad 2 may be injection molded onto the main body 30 of the temperature sensor 3, so that the thermal pad 2 and the temperature sensor 3 become an integrated piece. In the illustrated embodiment, the thermal pad 2 is block shaped and has an arc-shaped contact surface 2a suitable for being attached to the outer peripheral surface of the power terminal 50, in order to increase the thermal contact area between the thermal pad 2 and the power terminal 50.

When the temperature detection module 100 is inserted into the insertion slot 62 of the charging dock housing 6, the edge part 11a of the insulator 1 simultaneously presses against the multiple power terminals 50 inside the charging dock housing 6 to lock the multiple power terminals 50 in the charging dock housing 6.

As shown in FIGS. 1-13, in another exemplary embodiment of the present invention, a charging dock is also disclosed. The charging dock includes: a charging dock housing 6, a terminal assembly 5, and a temperature detection module 100. The charging dock housing 6 is formed with a terminal socket 61 and an insertion slot 62 communicated with the terminal socket 61. The terminal assembly 5 includes a power terminal 50 and is inserted into the terminal socket 61. The temperature detection module 100 is inserted into the insertion slot 62 from the outside of the charging dock housing 6. The thermal pad 2 of the temperature detection module 100 is in thermal contact with the power terminal 50 to transfer the heat of the power terminal 50 to the temperature sensor 3.

In the illustrated embodiment, multiple buckles 66 are formed on the outer side of the peripheral wall of the insertion slot 62 of the charging dock housing 6, and the multiple buckles 66 are distributed around the insertion slot 62 at intervals for respectively engaging with the multiple protrusions 16 on the insulator 1 of the temperature detection module 100 to lock the temperature detection module 100 in the insertion slot 62. The axial direction of the insertion slot 62 is perpendicular to the axial direction of the terminal socket 61, and the temperature detection module 100 is inserted into the insertion slot 62 along the radial direction of the terminal socket 61. In the illustrated embodiment, the cross-section of the insertion slot 62 is elliptical in shape.

The power terminal 50 includes a cylindrical part 51 and a connection part 52. The cylindrical part 51 is used for mating with a mating power terminal (not shown). The connection part 52 is connected to the rear end of the cylindrical part 51 for electrical connection to a cable 53. In the illustrated embodiment, the connection part 52 is flat and welded to the conductor end of the cable 53. The edge part 11a of the insulator 1 of the temperature detection module 100 is axially pressed against the rear end surface of the cylindrical part 51 of the power terminal 50 to lock the power terminal 50 in the terminal socket 61.

The terminal assembly 5 further includes a cable 53 and a sealing plug 54. The cable 53 is electrically connected to the connection part 52 of power terminal 50. The sealing plug 54 is fitted onto the cable 53 and inserted into the rear port of the terminal socket 61. The terminal assembly 5 is inserted through the rear port of the terminal socket 61, and the sealing plug 54 is used to seal the rear port of terminal socket 61.

The charging dock housing 6 has multiple terminal sockets 61, and the charging dock has multiple terminal assemblies 5 respectively inserted into the multiple terminal sockets 61. The insertion slot 62 is communicated with the multiple terminal sockets 61, and the temperature detection module 100 includes multiple thermal pads 2 in thermal contact with the power terminals 50 of multiple terminal assemblies 5, and multiple temperature sensors 3 for detecting the temperature of the multiple power terminals 50, respectively. In the illustrated embodiment, the edge part 11a of the insulator 1 of the temperature detection module 100 is simultaneously axially pressed against the rear end surfaces of the cylindrical parts 51 of the multiple power terminals 50 to lock the multiple power terminals 50 in the terminal socket 61. In the illustrated embodiment, the charging dock housing 6 is an integral injection molded part.

In the embodiments shown in FIGS. 1-18, the protrusion 16 on the temperature detection module 100 is engaged with the buckle 66 on the charging dock housing 6, and the temperature detection module 100 is locked to the charging dock housing 6 by the buckle. However, the present invention is not limited to the illustrated embodiment. For example, the temperature detection module 100 can also be fixed to the charging dock housing 6 in other suitable ways.

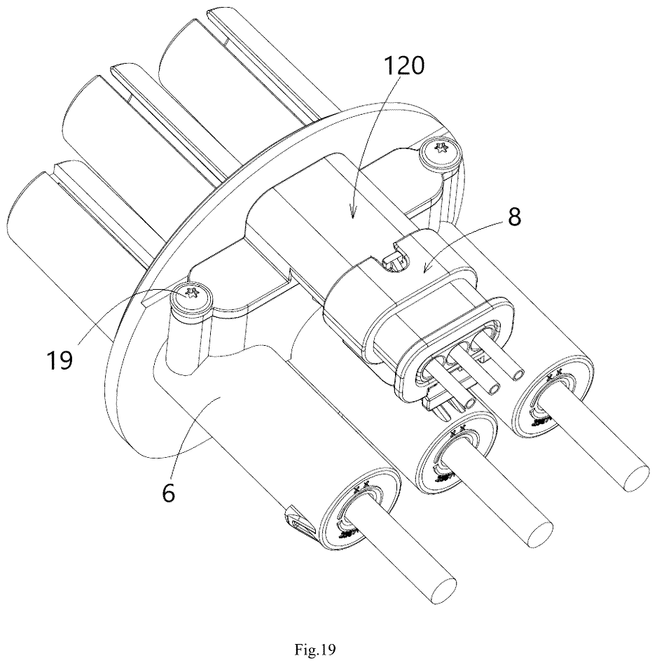

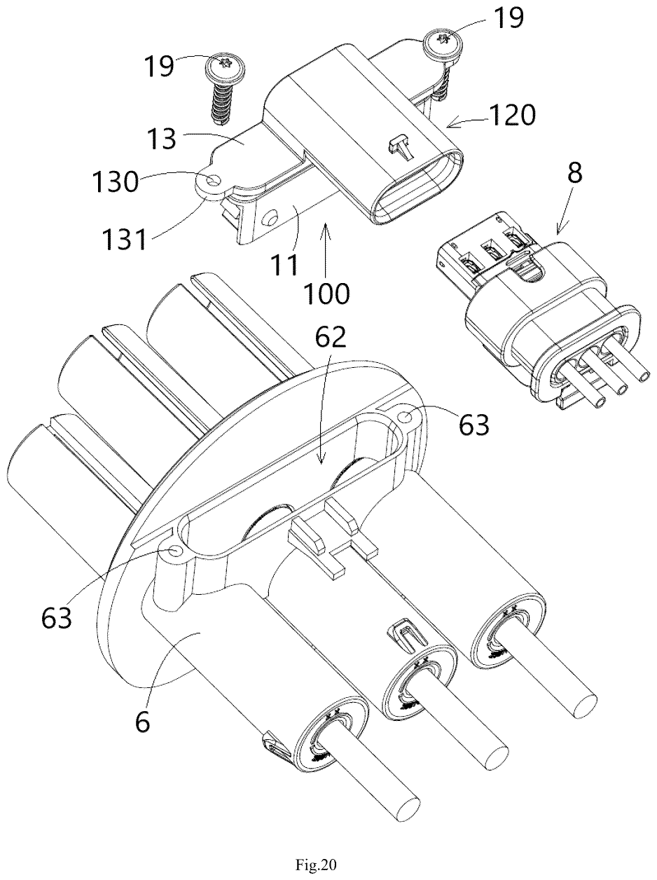

FIG. 19 shows an illustrative perspective view of a charging dock assembly according to another exemplary embodiment of the present invention. FIG. 20 shows an illustrative exploded view of a charging dock assembly according to another exemplary embodiment of the present invention.

The only difference between the charging dock assembly shown in FIGS. 19 and 20 and the charging dock assembly shown in FIGS. 1-18 is the fixing method of the temperature detection module 100 to the charging dock housing 6. The other technical features of the charging dock assembly shown in FIGS. 19 and 20 are basically the same as those shown in FIGS. 1 to 18, and can be referred to as the charging dock assembly shown in FIGS. 1 to 18.

As shown in FIGS. 19 and 20, in the illustrated embodiment, the bracket part 11 has a cover plate part 13 for covering the entrance of the insertion slot 62 of the charging dock housing 6. Multiple connecting ears 131 are formed on the outer peripheral surface of the cover plate part 13, and the multiple connecting ears 131 are distributed around the outer periphery of the cover plate part 13 at intervals. A connection hole 130 is formed in the connecting ear 131, and a threaded hole 63 is formed in the charging dock housing 6. The temperature detection module 100 also includes a threaded connection piece 19, which passes through the connection hole 130 in the connecting ear 131 and is threaded into the threaded hole 63 in the charging dock housing 6 to fasten the temperature detection module 100 to the charging dock housing 6.

It should be appreciated for those skilled in this art that the above embodiments are intended to be illustrated, and not restrictive. For example, many modifications may be made to the above embodiments by those skilled in this art, and various features described in different embodiments may be freely combined with each other without conflicting in configuration or principle.

Although several exemplary embodiments have been shown and described, it would be appreciated by those skilled in the art that various changes or modifications may be made in these embodiments without departing from the principles and spirit of the disclosure, the scope of which is defined in the claims and their equivalents.

As used herein, an element recited in the singular and proceeded with the word “a” or “an” should be understood as not excluding plural of said elements or steps, unless such exclusion is explicitly stated. Furthermore, references to “one embodiment” of the present invention are not intended to be interpreted as excluding the existence of additional embodiments that also incorporate the recited features. Moreover, unless explicitly stated to the contrary, embodiments “comprising” or “having” an element or a plurality of elements having a particular property may include additional such elements not having that property.

1. A charging dock, comprising:
a charging dock housing having:
a terminal socket;
a limiting feature; and
an insertion slot communicated with the terminal socket;
a terminal assembly comprising a power terminal and inserted into the terminal socket; and
a temperature detection module inserted into the insertion slot from the outside of the charging dock housing and adapted to detect the temperature of the power terminal, the temperature detection module including a connector interface arranged outside the charging dock housing and adapted to mate with a connector, wherein:
when the temperature detection module is inserted into a predetermined installation position, the limiting feature does not interfere with a connector housing to allow the connector to mate with the connector interface; and
when the temperature detection module is not inserted into the predetermined installation position, the limiting feature interferes with the connector housing, preventing the connector from being mated with the connector interface.

2. The charging dock according to claim 1, wherein:
the limiting feature is adapted to engage with a mating feature on the connector housing; and
when the temperature detection module is inserted into the predetermined installation position and the connector is mated with the connector interface, the limiting feature on the charging dock housing engages with the mating feature on the connector housing such that the connector housing is engaged to the charging dock housing.

3. The charging dock according to claim 2, wherein the limiting feature on the charging dock housing is shaped as a protruding tongue or column and is adapted to engage with a slot on the connector housing.

4. The charging dock according to claim 2, wherein:
when the temperature detection module is inserted into the predetermined installation position, the limiting feature is aligned with the mating feature on the connector housing to allow the connector to mate with the connector interface; and
when the temperature detection module is not inserted into the predetermined installation position, the limiting feature is not aligned with the mating feature on the connector housing, preventing the connector from being mated with the connector interface.

5. The charging dock according to claim 1, wherein the temperature detection module comprises:
an insulator;
a thermal pad assembled onto the insulator for thermal contact with the power terminal;
a temperature sensor provided in the thermal pad to detect the temperature of the power terminal; and
a conductive lead provided in the insulator and electrically connected to the temperature sensor, wherein the thermal pad comes into thermal contact with the power terminal when the temperature detection module is inserted into the predetermined installation position, to transfer the heat of the power terminal to the temperature sensor.

6. The charging dock according to claim 5, wherein the insulator is an injection molded part directly injected onto the conductive lead, so that the conductive lead and the insulator become an integrated piece.

7. The charging dock according to claim 5, wherein:
the conductive lead has a connection end electrically connected to the temperature sensor and an external pin for electrical connection with a connection terminal of the connector; and
the insulator comprises:
a bracket part adapted to be inserted into the insertion slot of the charging dock housing; and
a mating part adapted to be positioned outside the charging dock housing, the thermal pad and the temperature sensor are installed on the bracket part, and the mating part has an insertion cavity that allows the connection terminal of the connector to be inserted, the external pin of the conductive lead extends into the insertion cavity, and the mating part and the external pin constitute the connector interface.

8. The charging dock according to claim 7, wherein a sealing ring installation groove is formed on the outer peripheral surface of the bracket part, and the temperature detection module further comprises a sealing ring installed in the sealing ring installation groove, the sealing ring is adapted to be compressed between the bracket part and the inner wall surface of the insertion slot of the charging dock housing to achieve sealing between the two.

9. The charging dock according to claim 7, wherein:
the bracket part has a cover plate part covering the entrance of the insertion slot of the charging dock housing, and multiple protrusions are formed on the outer peripheral surface of the cover plate part and are distributed around the outer periphery of the cover plate part at intervals; and
multiple buckles are formed on the outer side of the peripheral wall of the insertion slot of the charging dock housing, the multiple buckles are distributed around the insertion slot at intervals and respectively engage with the multiple protrusions to lock the temperature detection module to the charging dock housing.

10. The charging dock according to claim 7, wherein:
the bracket part has a cover plate part for covering the entrance of the insertion slot of the charging dock housing, and a plurality of connecting ears are formed on the outer peripheral surface of the cover plate part, which are distributed around the outer periphery of the cover plate part at intervals; and
a connection hole is formed in the connecting ear, and a threaded hole is formed in the charging dock housing, the temperature detection module further comprises a threaded connection piece, which passes through the connection hole in the connecting ear and is threaded into the threaded hole in the charging dock housing to fasten the temperature detection module to the charging dock housing.

11. The charging dock according to claim 7, wherein:
the conductive lead includes a positive lead and a negative lead electrically connected to the positive pin and the negative pin of the temperature sensor, respectively; and
the external pins of the positive lead and the negative lead extend into the insertion cavity of the mating part for electrical connection with the connecting terminals of the inserted connector.

12. The charging dock according to claim 7, wherein the charging dock housing has multiple terminal sockets, the charging dock comprises multiple terminal assemblies respectively inserted into the multiple terminal sockets, the insertion slot is communicated with the multiple terminal sockets, and the temperature detection module comprises multiple thermal pads in thermal contact with the power terminals of the multiple terminal assemblies and multiple temperature sensors for detecting the temperature of the multiple power terminals respectively.

13. The charging dock according to claim 12, wherein:
the conductive lead includes multiple positive leads and a single negative lead; and
the connection ends of the multiple positive leads are respectively electrically connected to the positive pins of the multiple temperature sensors, and the single negative lead has multiple connection ends respectively electrically connected to the negative pins of the multiple temperature sensors.

14. The charging dock according to claim 5, wherein:
the thermal pad is block shaped, and a recessed receiving part is formed on the insulator, the thermal pad is positioned and installed into the receiving part; and
a socket is formed in the insulator, and an elastic buckle that engages with the socket is formed on the thermal pad to lock the thermal pad onto the insulator.

15. The charging dock according to claim 5, wherein a mounting slot is formed in the thermal pad, and the main body of the temperature sensor is inserted into the mounting slot of the thermal pad, the positive pin and negative pin of the temperature sensor extend from the thermal pad.

16. The charging dock according to claim 5, wherein the thermal pad is block shaped and has an arc-shaped contact surface suitable for being attached to the outer peripheral surface of the power terminal to increase the thermal contact area between the thermal pad and the power terminal.

17. The charging dock according to claim 5, wherein the axial direction of the insertion slot is perpendicular to the axial direction of the terminal socket, and the temperature detection module is inserted into the insertion slot along the radial direction of the terminal socket.

18. The charging dock according to claim 17, wherein the power terminal comprises:
a cylindrical part, used for mating with a mating power terminal; and
a connection part which is connected to the rear end of the cylindrical part for electrical connection to a cable, the edge part of the insulator of the temperature detection module is axially pressed against the rear end surface of the cylindrical part of the power terminal to lock the power terminal in the terminal socket.

19. The charging dock according to claim 18, wherein the terminal assembly further comprises:
a cable electrically connected to the connection part of the power terminal; and
a sealing plug fitted onto the cable and inserted into the rear port of the terminal socket, the terminal assembly is inserted through the rear port of the terminal socket, and the sealing plug is adapted to seal the rear port of the terminal socket.

20. The charging dock according to claim 5, wherein when the temperature detection module is inserted into the insertion slot of the charging dock housing, the edge part of the insulator is pressed against the power terminal inside the charging dock housing to lock the power terminal in the charging dock housing.

21. The charging dock according to claim 1, wherein the charging dock housing is an integral injection molded part.

22. A charging dock assembly, comprising:
a charging dock, including:
a charging dock housing having a terminal socket, a limiting feature; and an insertion slot communicated with the terminal socket;
a terminal assembly having a power terminal and inserted into the terminal socket; and
a temperature detection module inserted into the insertion slot from the outside of the charging dock housing and adapted to detect the temperature of the power terminal, the temperature detection module including a connector interface arranged outside the charging dock housing and adapted to mate with a connector, wherein when the temperature detection module is inserted into a predetermined installation position, the limiting feature does not interfere with a connector housing to allow the connector to mate with the connector interface, and when the temperature detection module is not inserted into the predetermined installation position, the limiting feature interferes with the connector housing, preventing the connector from being mated with the connector interface; and
a connector mated with the connector interface of the temperature detection module of the charging dock.

23. The charging dock assembly according to claim 22, wherein the connector comprises:
a connector housing; and
a connection terminal arranged in the connector housing, a mating feature is formed on the connector housing and is adapted to engage with the limiting feature on the charging dock housing, and the connection terminal is electrically connected to the external pin of the temperature detection module.

24. The charging dock assembly according to claim 23, wherein the connector further comprises a signal cable electrically connected to the connection terminal and led out from the connector housing.
